(19) United States
(12) Patent Application Publication
(10) Pub. No.: US 2016/0197341 A1
(43) Pub. Date: Jul. 7, 2016

(54) CATHODE COMPOSITIONS FOR LITHIUM-ION BATTERIES

(71) Applicant: 3M INNOVATIVE PROPERTIES COMPANY, Saint Paul, MN (US)

(72) Inventors: Zhonghua Lu, White Bear Lake, MN (US); Kevin W. Eberman, St. Paul, MN (US); Matthew J Triemert, White Bear Lake, MN (US)

(21) Appl. No.: 14/910,840

(22) PCT Filed: Aug. 6, 2014
(86) PCT No.: PCT/US14/49884

§ 371 Date: Feb. 8, 2016

Related U.S. Application Data
(60) Provisional application No. 61/868,905, filed on Aug. 22, 2013.

(51) Int. Cl. H01M 4/36; H01M 10/0525; H01M 4/58; H01M 4/525; H01M 4/505

(52) U.S. Cl. CPC H01M 4/366; H01M 4/525; H01M 4/505; H01M 4/5825; H01M 10/0525; H01M 2004/028

(57) ABSTRACT

A cathode composition is provided. The composition includes particles having the following formula Li[Liₓ(NiₐMn_{b}Co_{c})₁₋ₓ]O₂, where 0<x<0.3, 0<a<1, 0<b<1, 0<c<1, a+b+c=1, a/b≦1. The composition further includes a coating composition having the formula Li_{f}Co_{g}[PO₄]_{1-f-g} (0≦f<1, 0≦g<1). The coating composition is disposed on an outer surface of the particles.

### CROSS REFERENCE TO RELATED APPLICATIONS

This application claims priority to U.S. Provisional Patent Application No. 61/868,905, filed Aug. 22, 2013, the disclosure of which is incorporated by reference in its entirety herein.

### GOVERNMENT RIGHTS

The U.S. Government may have certain rights to this invention under the terms of Contract No. DE-EE0005499 granted by the U.S. Department of Energy.

### TECHNICAL FIELD

The present disclosure relates to compositions useful as cathodes for lithium-ion electrochemical cells.

### BACKGROUND

Various coated cathode compositions have been introduced for use in lithium-ion electrochemical cells. For example, U.S. Pat. No. 6,489,060B1 discusses that spinel structured compounds coated with the decomposition compounds of one or more compounds of foreign metal have reduced battery capacity fade rate.

### BRIEF DESCRIPTION OF THE DRAWINGS

The disclosure may be more completely understood in consideration of the following detailed description of various embodiments of the disclosure in connection with the accompanying figures, in which:

FIGS. 1A and 1B illustrate voltage profile curves of Example 1 and Comparative Example 1, respectively, between 2.5-4.7V vs. Li/Li+ using current C/15 (1C=200 mAh/g) at 30° C.

FIGS. 2A, 2B, and 2C illustrate capacity retention curves of Example 1, Comparative Example 1, and BC-723K, respectively, between 2.5-4.7V vs. Li/Li+ at 30° C.

FIGS. 3A and 3B illustrate the morphology of Example 1 (800° C. baked) and Comparative Example 1 (500° C. baked), respectively, obtained by Scanning Electron Microscopy.

FIGS. 4A and 4B illustrate x-ray diffraction patterns of Example 1 and Comparative Example 1, respectively.

FIG. 5 is a chart that provides capacity loss data, obtained via floating test, for cathode powders at 4.6V and 50° C. (Smaller loss is better)

FIG. 6 illustrates a plot of capacity retention improvement vs. Ni/Mn ratio.

FIGS. 7A and 7B illustrate voltage profile curves of Example 8 and Comparative Example 4, respectively, between 2.5-4.7V vs. Li/Li+ using current C/15 (1C=200 mAh/g) at 30° C.

FIGS. 8A, 8B, and 8C illustrate capacity retention curves for Example 8, Comparative Example 4, and BC-723K, respectively, between 2.5-4.7V vs. Li/Li+ at 30° C.

FIGS. 9A and 9B illustrate voltage profile curves of Example 3 and Comparative Example 5, respectively, between 2.5-4.7V vs. Li/Li+ using current C/15 (1C=200 mAh/g) at 30° C.

FIGS. 10A and 10B illustrate voltage profile curves of Example 2 and Comparative Example 6, respectively, between 2.5-4.7V vs. Li/Li+ using current C/15 (1C=200 mAh/g) at 30° C.

### DETAILED DESCRIPTION

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

High energy lithium ion batteries require higher volumetric energy electrode materials than conventional lithium ion batteries. With the introduction of metal alloy anode materials into batteries, because such anode materials have high reversible capacity (much higher than conventional graphite), cathode materials of commensurately high capacity are desirable.

In order to obtain a higher capacity from a cathode material, cycling the cathode to a wider electrochemical window is an approach. Conventional cathodes cycle well only to 4.3V vs. Li/Li+. Cathode compositions which could cycle well to 4.7V or higher vs. Li/Li+, however, would be particularly advantageous. In order to improve the battery fade at high voltage, surface treatment or coating of electrodes with compounds having high voltage stability has been explored. However, heretofore, such surface treatments have not achieved optimum cycle life performance in electrochemical cells which employ nickel-manganese-cobalt (NMC) cathode compositions.

Generally, the present application is directed to cathode compositions having lithium metal oxide particles. The particles may include Ni, Mn, and Co, and may bear thereon one or more phosphate-based coatings. It has been discovered that for such cathode compositions, surprisingly beneficial results may be achieved for particular combinations of phosphate coatings and NMC cathode formulas, and/or by subjecting the compositions to particular processing conditions (e.g., baking).

In various embodiments, the lithium transition metal oxide compositions of the present disclosure may include particles having the general formula: Li[Liₓ(NiₐMn_{b}Co_{c})₁₋ₓ]O₂, where 0<x<0.3, 0<a<1, 0<b<1, 0<c<1, a+b+c=1, a/b<1 or a/b=1 or a/b is between 0.95 and 1.05. For such compositions, useful phosphate-based coating may include those having the formula LiCoPO₄, Li_{f}Co_{g}[PO₄]_{1-f-g} or Li_{f}M_{g}[PO₄]_{1-f-g} where M is the combination Co and/or Ni and/or Mn and 0≦f<1, 0≦g<1).

In some embodiments, the lithium transition metal oxide compositions of the present disclosure may include particles having the following formula Li[Liₓ(NiₐMn_{b}Co_{c})₁₋ₓ]O₂, where 0<x<0.3, 0<a<1, 0<b<1, 0<c<1, a+b+c=1 or 0.1≦a≦0.8, 0.1≦b≦0.8, 0.1≦c≦0.8. For such compositions, useful phosphate-based coating may include those having the formula Mₕ[PO₄]₁₋ₕ (0<h<1), where M may include Ca, Sr, Ba, Y, any rare earth element (REE) or combinations thereof. For example, phosphate-based coating may include those having the formula Ca_{1.5}PO₄ or LaPO₄. Following application of the phosphate-based coatings to the particles, in some embodiments, the coated particles may be subjected to a baking process in which the particles are heated to a temperature of at least 700° C., at least 750° C., or at least 800° C. for at least 30 minutes, at least 60 minutes, or at least 120 minutes. It is believed that for at least some of the phosphate-based coatings of the present disclosure, such a processing step effects a morphology change or composition in the coating material or the surface composition of the bulk oxide which contributes to an improvement in battery cycle life.

While the present disclosure is directed toward phosphate coatings, it is to be appreciated that other coatings, for example MₘSO₄₍₁₋ₘ₎, where M includes Ca, Sr, Ba, Y, any rare earth element (REE) or combinations thereof and 0<m<1, may be used.

The compositions of the preceding embodiments may be in the form of a single phase having an O3 crystal structure. The compositions may not undergo a phase transformation to a spinel crystal structure when incorporated in a lithium-ion battery and cycled for at least 40 full charge-discharge cycles at 30° C. and a final capacity of greater than 130 mAh/g using a discharge current of 30 mA/g.

As used herein, the phrase “O3 crystal structure” refers to a lithium metal oxide composition having a crystal structure consisting of alternating layers of lithium atoms, transition metal atoms and oxygen atoms. Among these layered cathode materials, the transition metal atoms are located in octahedral sites between oxygen layers, making a MO2 sheet, and the MO2 sheets are separated by layers of the alkali metals such as Li. They are classified in this way: the structures of layered AxMO2 bronzes into groups (P2, O2, O6, P3, O3). The letter indicates the site coordination of the alkali metal A (prismatic (P) or octahedral (O)) and the number gives the number of MO2 sheets (M) transition metal) in the unit cell. The O3 type structure is generally described in Zhonghua Lu, R. A. Donaberger, and J. R. Dahn, Superlattice Ordering of Mn, Ni, and Co in Layered Alkali Transition Metal Oxides with P2, P3, and O3 Structures, Chem. Mater. 2000, 12, 3583-3590, which is incorporated by reference herein in its entirety. As an example, α-NaFeO₂ (R-3m) structure is an O3 type structure (super lattice ordering in the transition metal layers often reduces its symmetry group to C2/m). The terminology O3 structure is also frequently used referring to the layered oxygen structure found in LiCoO₂.

The compositions of the present disclosure have the formulae set forth above. The formulae themselves reflect certain criteria that have been discovered and are useful for maximizing performance. First, the compositions adopt an O3 crystal structure featuring layers generally arranged in the sequence lithium-oxygen-metal-oxygen-lithium. This crystal structure is retained when the composition is incorporated in a lithium-ion battery and cycled for at least 40 full charge-discharge cycles at 30° C. and a final capacity of above 130 mAh/g using a discharge current of 30 mA/g, rather than transforming into a spinel-type crystal structure under these conditions.

The above-described cathode compositions may be synthesized by, first, jet milling or by combining precursors of the metal elements (e.g., hydroxides, nitrates, and the like), followed by heating to generate the cathode particles. Heating may be conducted in air at temperatures of at least about 600° C. or at least 800° C. The particles may then be coated by, first dissolving the coating material in solution (e.g., DI-water), and then incorporating the cathode particles into the solution. The coated particles may then be subjected to a baking process in which the particles are heated to a temperature of at least 700° C., at least 750° C., or at least 800° C. for at least 30 minutes, at least 60 minutes, or at least 120 minutes. Alternatively, the cathode particle generation and surface coating may completed in a single firing steps at temperature of at least 700° C., at least 750° C., or at least 800° C. for at least 30 minutes, at least 60 minutes, or at least 120 minutes.

In further embodiments, the lithium transition metal oxide compositions of the present disclosure may include particles having a “core-shell” type construction. The core may include a layered lithium metal oxide having an O3 crystal structure. If the layered lithium metal oxide is incorporated into a cathode of a lithium-ion cell, and the lithium-ion cell is charged to at least 4.6 volts versus Li/Li+ and then discharged, then the layered lithium metal oxide exhibits no dQ/dV peaks below 3.5 volts. Generally, such materials have a molar ratio of Mn:Ni, if both Mn and Ni are present, that is less than or equal to one.

Examples of layered lithium metal oxides for the core include, but are not limited to Li[Li_{w}NiₓMn_{y}Co_{z}Mₚ]O₂ wherein: M is a metal other than Li, Ni, Mn, or Co; 0<w, ⅓; 0≦x≦1; 0≦y≦⅔; 0≦z≦1; 0≦p<0.15; w+x+y+z+p=1; and the average oxidation state of the metals within the brackets is three, including Li[Ni_{0.5}Mn_{0.5}]O₂ and Li[Ni_{2/3}Mn_{1/3}]O₂. X-ray diffraction (XRD), well-known in the art, can be used to ascertain whether or not the material has a layered structure.

Certain lithium transition metal oxides do not readily accept significant additional amount of excess lithium, do not display a well-characterized oxygen-loss plateau when charged to a voltage above 4.6 V, and on discharge do not display a reduction peak below 3.5V in dQ/dV. Examples include Li[Ni_{2/3}Mn_{1/3}]O₂, Li[Ni_{0.42}Mn_{0.42}Co_{0.16}]O₂, and Li[Ni_{0.5}Mn_{0.5}]O₂. Such oxides may be useful as core materials.

In some embodiments, the core can include from 30 to 85 mole percent, from 50 to 85 mole percent, or from 60 to 80 or 85 mole percent, of the composite particle, based on the total moles of atoms of the composite particle.

In various embodiments, the shell layer of the core-shell construction may include an oxygen-loss, layered lithium metal oxide having an O3 crystal structure configuration. In some embodiments, the oxygen-loss layered metal oxide comprises lithium, nickel, manganese, and cobalt in an amount allowing the total cobalt content of the composite metal oxide to be less than 20 mole percent. Examples include, but are not limited to, solid solutions of Li[Li_{1/3}Mn_{2/3}]O₂ and Li[NiₓMn_{y}Co_{z}]O₂, wherein 0≦x≦1, 0≦y≦1, 0≦z≦0.2, and wherein x+y+z=1, and the average oxidation state of the transition metals is three, excluding the materials listed above under the core material definition that do not show particular strong oxygen loss characteristics. Useful shell materials may include, for example, Li[Li_{0.2}Mn_{0.54}Ni_{0.13}Co_{0.13}]O₂ and Li[Li_{0.06}Mn_{0.525}Ni_{0.415}]O₂ as well as additional materials described in Lu et al. in Journal of The Electrochemical Society, 149 (6), A778-A791 (2002), and Arunkumar et al. in Chemistry of Materials, 19, 3067-3073 (2007). Generally, such materials have a molar ratio Mn:Ni, if both are present, greater than or equal to one.

In illustrative embodiments, the shell layer may include from 15 to 70 mole percent, from 15 to 50 mole percent, or from 15 or 20 mole percent to 40 mole percent, of the composite particle, based on the total moles of atoms of the composite particle.

The shell layer may have any thickness subject to the restrictions on composition of the composite particle described above. In some embodiments, the thickness of the shell layer is in a range of from 0.5 to 20 micrometers.

Composite particles according to the present disclosure may have any size, but in some embodiments, have an average particle diameter in a range of from 1 to 25 micrometers.

In some embodiments, the charge capacity of the composite particle is greater than the capacity of the core.

In various embodiments, coating compositions useful for the above-described core-shell type particles may include those having the formula Li₍₃₋₂ₖ₎MₖPO₄, where M is Ni, Co, Mn, or combinations thereof, and 0≦k≦1.5 or Li_{f}M_{g}[PO₄]_{1-f-g} where M is combination Co and/or Ni and/or Mn and 0≦f<1, 0≦g<1) or Mₕ[PO₄]₁₋ₕ (0<h<1), where M may include Ca, Sr, Ba, Y, any rare earth element (REE) or combinations thereof. For example, a coating composition having the formula LiCoPO₄ may be employed. As with the prior embodiments, following application of the phosphate-based coatings to the core-shell particles, the particles may be subjected to a baking process in which the particles are heated to a temperature of at least 700° C., at least 750° C., or at least 800° C. for at least 30 minutes, at least 60 minutes, or at least 120 minutes.

The core-shell type particles according to the present disclosure can be made by various methods. In one method, core precursor particles comprising a first metal salt are formed, and used as seed particles for the shell layer, which comprises a second metal salt deposited on at least some of the core precursor particles to provide composite particle precursor particles. In this method, the first and second metal salts are different. The composite particle precursor particles are dried to provide dried composite particle precursor particles, which are combined with a lithium source material to provide a powder mixture. The powder mixture is then fired (that is, heated to a temperature sufficient to oxidize the powder in air or oxygen) to provide composite lithium metal oxide particles according to the present disclosure.

For example, a core precursor particle, and then a composite particle precursor, may be formed by stepwise (co)precipitation of one or more metal oxide precursors of a desired composition (first to form the core and then to form the shell layer) using stoichiometric amounts of water-soluble salts of the metal(s) desired in the final composition (excluding lithium and oxygen) and dissolving these salts in an aqueous solution. As examples, sulfate, nitrate, oxalate, acetate and halide salts of metals can be utilized. Exemplary sulfate salts useful as metal oxide precursors include manganese sulfate, nickel sulfate, and cobalt sulfate. The precipitation is accomplished by slowly adding the aqueous solution to a heated, stirred tank reactor under inert atmosphere, together with a solution of sodium hydroxide or sodium carbonate. The addition of the base is carefully controlled to maintain a constant pH. Ammonium hydroxide additionally may be added as a chelating agent to control the morphology of the precipitated particles, as will be known by those of ordinary skill in the art. The resulting metal hydroxide or carbonate precipitate can be filtered, washed, and dried thoroughly to form a powder. To this powder can be added lithium carbonate or lithium hydroxide to form a mixture. The mixture can be sintered, for example, by heating it to a temperature of from 500° C. to 750° C. for a period of time from between one and 10 hours. The mixture can then be oxidized by firing in air or oxygen to a temperature from 700° C. to above about 1000° C. for an additional period of time until a stable composition is formed. This method is disclosed, for example, in U.S. Patent Application Publication No. 2004/0179993 (Dahn et al.), and is known to those of ordinary skill in the art.

In a second method, a shell layer comprising a metal salt is deposited on at least some of preformed core particles comprising a layered lithium metal oxide to provide composite particle precursor particles. The composite particle precursor particles are then dried to provide dried composite particle precursor particles, which are combined with a lithium-ion source material to provide a powder mixture. The powder mixture is then fired in air or oxygen to provide core-shell type particles.

In some embodiments, the phosphate-based coatings may be applied to the core-shell type particles in the same manner described above. That is, by first dissolving the coating material in solution (e.g., DI-water), and then incorporating the particles into the solution. The coated particles may then be subjected to a baking process in which the particles are heated to a temperature of at least 700° C., at least 750° C., or at least 800° C. for at least 30 minutes, at least 60 minutes, or at least 120 minutes. Alternatively, the cathode particle generation and surface coating may completed in a single firing steps at temperature of at least 700° C., at least 750° C., or at least 800° C. for at least 30 minutes, at least 60 minutes, or at least 120 minutes.

In any of the above-described embodiments, the coatings may be present on the surfaces of the particles at an average thickness of at least 1.0 nanometer but no more than 4 micrometers. The coatings may be present on the particles at between 0.5 and 10 wt. %, between 0.5 and 7 wt. %, or between 0.5 and 5 wt. % based on the total weight of the coated particles.

In some embodiments, to make a cathode from the cathode compositions of the present disclosure, the cathode composition and selected additives such as binders (e.g., polymeric binders), conductive diluents (e.g., carbon), fillers, adhesion promoters, thickening agents for coating viscosity modification such as carboxymethylcellulose or other additives known by those skilled in the art can be mixed in a suitable coating solvent such as water or N-methylpyrrolidinone (NMP) to form a coating dispersion or coating mixture. The coating dispersion or coating mixture can be mixed thoroughly and then applied to a foil current collector by any appropriate coating technique such as knife coating, notched bar coating, dip coating, spray coating, electrospray coating, or gravure coating. The current collectors can be thin foils of conductive metals such as, for example, copper, aluminum, stainless steel, or nickel foil. The slurry can be coated onto the current collector foil and then allowed to dry in air followed by drying in a heated oven, typically at about 80° C. to about 300° C. for about an hour to remove all of the solvent.

The present disclosure further relates to lithium-ion batteries. In some embodiments, the cathode compositions of the present disclosure can be combined with an anode and an electrolyte to form a lithium-ion battery. Examples of suitable anodes include lithium metal, carbonaceous materials, silicon alloy compositions, and lithium alloy compositions. Exemplary carbonaceous materials can include synthetic graphites such as mesocarbon microbeads (MCMB) (available from E-One Moli/Energy Canada Ltd., Vancouver, BC), SLP30 (available from TimCal Ltd., Bodio Switzerland), natural graphites and hard carbons. Useful anode materials can also include alloy powders or thin films. Such alloys may include electrochemically active components such as silicon, tin, aluminum, gallium, indium, lead, bismuth, and zinc and may also comprise electrochemically inactive components such as iron, cobalt, transition metal silicides and transition metal aluminides.

The lithium-ion batteries of the present disclosure can contain an electrolyte. Representative electrolytes can be in the form of a solid, liquid or gel. Exemplary solid electrolytes include polymeric media such as polyethylene oxide, polytetrafluoroethylene, polyvinylidene fluoride, fluorine-containing copolymers, polyacrylonitrile, combinations thereof and other solid media that will be familiar to those skilled in the art. Examples of liquid electrolytes include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, .gamma.-butylrolactone, methyl difluoroacetate, ethyl difluoroacetate, dimethoxyethane, diglyme (bis(2-methoxyethyl) ether), tetrahydrofuran, dioxolane, combinations thereof and other media that will be familiar to those skilled in the art. The electrolyte can be provided with a lithium electrolyte salt. The electrolyte can include other additives that will familiar to those skilled in the art.

In some embodiments, lithium-ion batteries of the present disclosure can be made by taking at least one each of a positive electrode and a negative electrode as described above and placing them in an electrolyte. A microporous separator, such as CELGARD 2400 microporous material, available from Celgard LLC, Charlotte, N.C., may be used to prevent the contact of the negative electrode directly with the positive electrode.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the numerous embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the numerous embodiments of the present disclosure. Furthermore, the particular features, structures, materials, or characteristics may be combined in any suitable manner in one or more embodiments.

While the specification has described in detail certain embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove.

Various exemplary embodiments have been described. These and other embodiments are within the scope of the following claims.

### Electrode Preparation

The active electrode materials were blended with Super P conductive carbon black (from MMM Carbon, Belgium). Polyvinylidine difluoride (PVDF) (from Aldrich Chemical Co.) was dissolved in N-methylpyrrolidone (NMP) solvent (from Aldrich Chemical Co.) to make PVDF solution with a concentration of about 7 wt %. The PVDF solution and N-methylpyrrolidone (NMP) solvent were added into the mixture of active electrode materials and Super P and use planetary mixer/deaerator Kurabo Mazerustar KK-50S (from Kurabo Industries Ltd) to form slurry dispersion. The dispersion slurry was coated on metal foil (Al for cathode active material; Cu for anode material such as graphite or alloy) using a coating bar, and the dried at 110° C. for 4 hrs to form a composite electrode coating. This coating was composed of 90 weight percent active material, 5 weight percent Super P and 5 weight percent of PVDF. The active cathode loading is about 8 mg/cm2. The MCMB type graphite (which were obtained from E-One Moli Energy Ltd) was used as active anode material. The active anode loading is about 9.4 mg/cm2.

### Preparation of Core-Shell Type NMC Oxide

A 10-liter closed stirred tank reactor was equipped with 3 inlet ports, a gas outlet port, a heating mantle, and a pH probe. To the tank was added 4 liters of 1M deaerated ammonium hydroxide solution. Stirring was commenced and the temperature was maintained at 60° C. The tank was kept inerted with an argon flow. Through one inlet port was pumped a 2M solution of NiSO₄.6H₂O and MnSO₄.H2O (Ni/Mn molar ratio of 2:1) at a rate of 4 ml/min. Through a second inlet port was added a 50 percent aqueous solution of NaOH at a rate to maintain a constant pH of 10.0 in the tank. Through the third inlet port was added concentrated aqueous ammonium hydroxide at a rate adjusted to maintain a 1M NH₄OH concentration in the reactor. Stirring at 1000 rpm was maintained. After 10 hrs, the sulfate and ammonium hydroxide flow was stopped, and the reaction was maintained for 12 hrs at 60° C. and 1000 rpm with the pH controlled at 10.0. The resulting precipitate was filtered, washed carefully several times, and dried at 110° C. for 10 hrs to provide a dry metal hydroxide in the form of spherical particles.

A stirred tank reactor was set up as above, except that the ammonia feed was kept closed. Deaerated ammonium hydroxide (4 liters, 0.2M) was added. Stirring was kept at 1000 rpm, and the temperature was maintained at 60° C. The tank was kept inerted with an argon flow. Metal hydroxide material as described above (200 g) was added as seed particles. Through one inlet port was pumped a 2M solution of NiSO₄.6H₂O, MnSO₄.H2O, and CoSO₄.7H₂O (metal atomic ratio Mn/Ni/Co=67.5/16.25/16.25) at a flow rate of 2 ml/min. Through a second inlet port was added a 50 percent aqueous solution of NaOH at a rate to maintain constant pH at 10.0 in the reactor. After 6 hrs, the sulfate flow was stopped, and the reaction maintained for 12 hrs at 60° C. and 1000 rpm, with the pH kept at 10.0. During this process, a shell coating was formed around the seed particles. The resulting precipitate was filtered, washed carefully several times, and dried at 110° C. for 10 hrs to provide a dry metal hydroxide as spherical composite particles. Based on energy dispersive X-ray spectroscopy (EDX) analysis, the core/shell mole ratio was estimated at 67/33.

A portion of the composite particles (10 g) was rigorously mixed in a mortar with the appropriate amount of LiOH.H₂O to form Li[Ni_{2/3}Mn_{1/3}]O2 (67 mole percent core) with Li[Li_{0.2}Mn_{0.54}Ni_{0.13}Co_{0.13}]O₂. (33 mole percent shell) after firing. The mixed powder was fired in air at 500° C. for 4 hrs then at 900° C. for 12 hrs to form composite particles with each of the core and shell having a layered lithium metal oxide having 03 crystal structure. Based on inductively coupled plasma (ICP) analysis the core/shell mole ratio was 67/33.

### Coin Cell Assembling and Cycling:

The cathode electrode and anode electrode were punched into circle shape and were incorporated into 2325 coin cell as known to one skilled in the art. The anode was MCMB type graphite or lithium metal foil. One layer of CELGARD 2325 microporous membrane (PP/PE/PP) (25 micron thickness, from Celgard, Charlotte, N.C.) was used to separate the cathode and anode. 100 ul electrolyte was added to be sure of the wetting of the cathode, membrane and anode. The coin cells were sealed and cycled using a Maccor series 2000 Cell cyclers (available from Maccor Inc. Tulsa, Okla., USA) at a temperature of 30° C. or 50° C.

### Example 1

The cathode powder for Ex. 1 (3 wt % LaPO₄ surface treated NMC442 (Li[Liₓ(Ni_{0.42}Mn_{0.42}Co_{0.16})₁₋ₓ]O₂ with x˜0.05) was prepared as follows: 166.99 g of La(NO₃)₃.6H₂O (≧98%, from Sigma-Aldrich) and 51.023 gram of (NH₄)₂HPO₄ (≧98%, from Sigma-Aldrich) were dissolved into 800 ml deionized (DI) water in a stainless steel cylindrical shape container and stirred for two hours. 3.0 kg of cathode power NMC442 (available as BC-723K from 3M, Li[Liₓ(Ni_{0.42}Mn_{0.42}Co_{0.16})₁₋ₓ]O₂ with x˜0.05) was then added slowly into the container to make a slurry. Small amounts of DI water were added as needed in order to keep the slurry stirring smoothly. The slurry was stirred overnight and then slowly heated, with stirring, to about 80° C. until the water was almost dried out and stirring ceased. The container was then heated at 100° C. in an oven overnight to dry out the water completely. The powder in the contained was tumbled to loosen and then baked at 800° C. for 4 hours. The powder was passed through 75 um pore sized sieves before use.

### Comparative Example 1

The cathode powder for Comparative Example 1 was prepared in the same manner as Example 1, except the powder was baked at 500° C. for 4 hours.

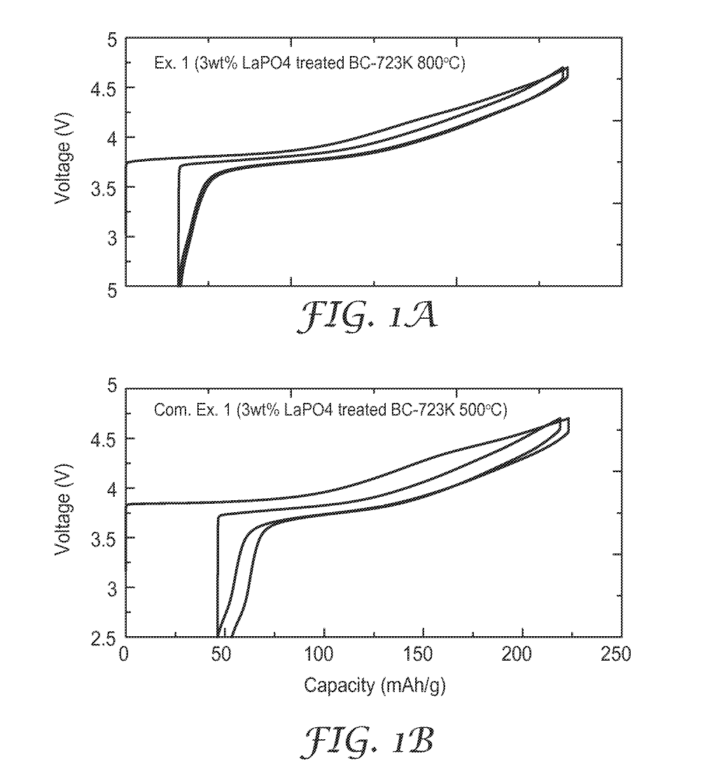

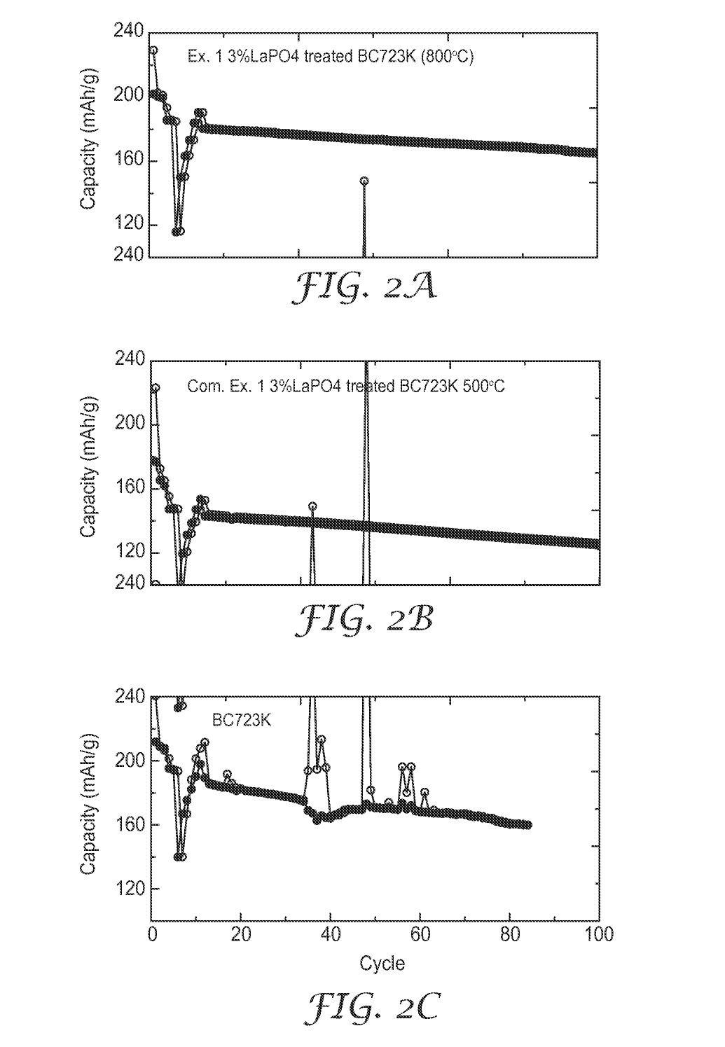

Example 1 (Ex 1) and Comparative Example 1 (Comp Ex 1) were tested in coin cells as cathodes, following the process as disclosed in the section of electrode preparation and coin cell assembling. Lithium metal foil was used as anode. The electrolyte was 1M LiPF6 in EC:DEC (1:2 by volume) (EC=Ethylene carbonate; DEC=Diethyl carbonate). These coin cells were cycled between 2.5-4.7V vs. Li/Li+ at 30° C. FIG. 1 shows the voltage profiles of Ex. 1 and Comp Ex 1 being cycled using constant current C/15 between 2.5-4.7V. (1C=200 mAh/g). It is clear that Ex 1 had a smaller irreversible capacity loss compared to Comparative Ex 1. FIG. 2 shows the capacity retention vs. cycle number. It was noted that Ex 1 had higher reversible capacity and better capacity retention than Comparative Ex 1 or the original powder BC-723K.

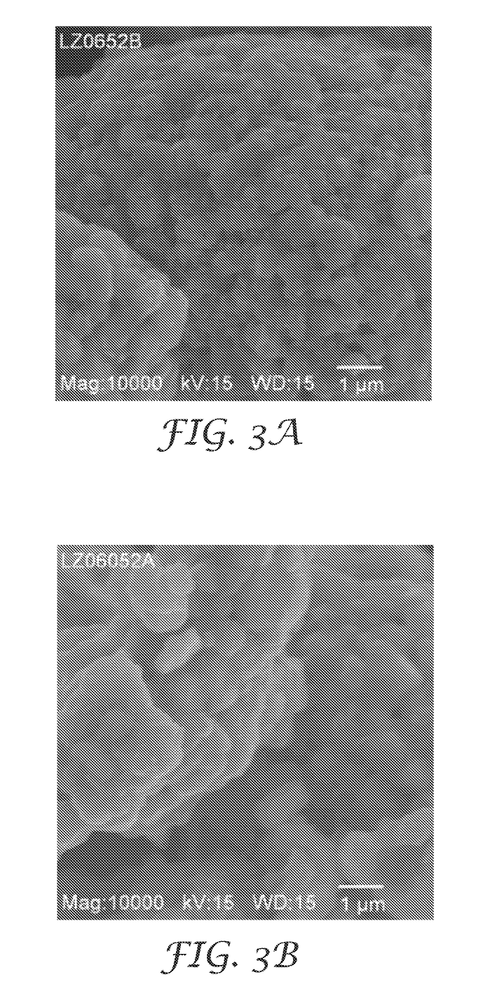

FIGS. 3 (a) and (b) show the particle morphology of the Ex 1 and Comp. Ex. 1. It was clear that the crystallite size of the coated material on the particles of Ex. 1 was larger than those for Comp. Ex. 1. This may be related to the heat treatment temperature difference.

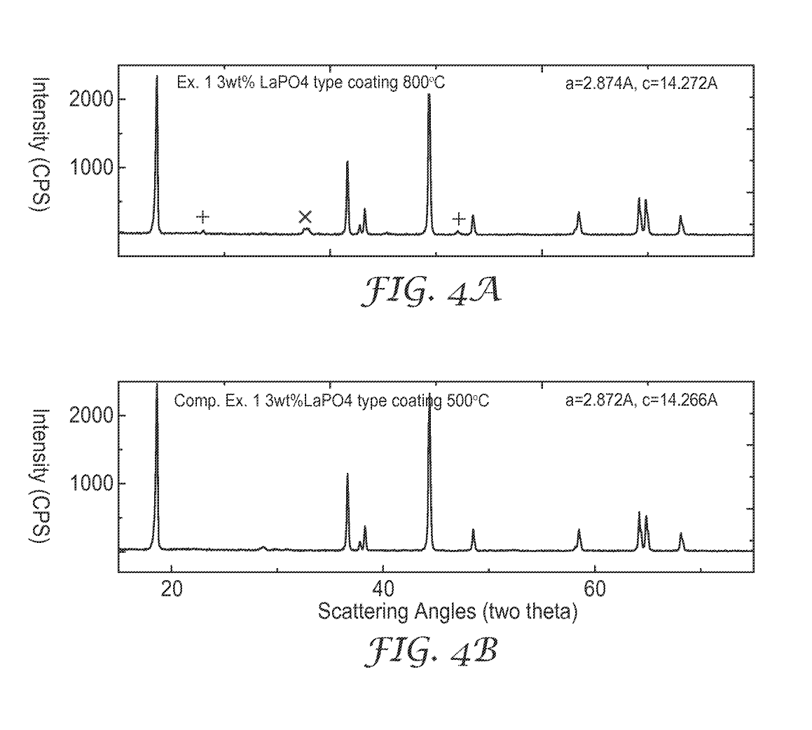

FIG. 4 shows the x-ray diffraction patterns of the Ext and Comp Ex 1. Both materials adopted an 03 type layered structure. The lattice constants were also listed in FIG. 4. For the original sample BC-723K, the lattice constant were: (a=2.872 Å; c=14.263 Å). Comparative Ex 1 had a similar lattice constant to the original untreated material, but this was not the case for Ex. 1. The x-ray diffraction pattern indicated that LaPO₄ type coating combining with 800° C. treatment temperature modified the structure of NMC442 (BC-723K). In addition, some extra small peaks between 20 and 50 degrees for Ex. 1 were observed. The strongest extra peak was located between 30 and 40 degrees and was marked with a cross symbol.

The table 1(a) and (b) show the element analysis by Energy Dispersive X-ray Spectroscopy of Example 1 and Comparative Ex 1. It is clear that both La and PO4 were detected on the surface of the particles.

TABLE 1a
Energy Dispersive X-ray Analysis of Example 1

| | Element atomic ratio | | | | |
|---|---|---|---|---|---|
| Location | P | Mn | Co | Ni | La |
| Pt1 | 0.3 | 42.79 | 15.5 | 41.2 | 0.21 |
| Pt2 | 0.63 | 41.2 | 16.21 | 40.66 | 1.29 |
| pt3 | 0.03 | 40.91 | 16.56 | 41.9 | 0.6 |
| pt4 | 0.09 | 41.78 | 16.04 | 41.72 | 0.37 |
| pt5 | 0.18 | 40.89 | 16.31 | 41.55 | 1.06 |
| pt6 | 0.06 | 41.57 | 16.5 | 41.77 | 0.1 |
| pt7 | 1.96 | 41.12 | 15.72 | 40.15 | 1.05 |
| pt8 | 0.72 | 43.24 | 15.56 | 39.96 | 1.11 |
| Average | 0.50 | 41.69 | 16.05 | 41.11 | 0.72 |

TABLE 1b
Energy Dispersive X-ray Analysis of Comparative Example 1

| | Element atomic ratio | | | | |
|---|---|---|---|---|---|
| Location | P | Mn | Co | Ni | La |
| Pt1 | 1.21 | 41.14 | 15.46 | 41.1 | 1.1 |
| Pt2 | 0.61 | 43.38 | 15.65 | 39.85 | 0.51 |
| pt3 | 1.16 | 41.24 | 15.03 | 40.34 | 2.23 |
| pt4 | 1.1 | 41.34 | 15.61 | 41.15 | 0.8 |
| pt5 | 0.38 | 38.76 | 16.38 | 43.99 | 0.5 |
| pt6 | 17.62 | 31.27 | 21.96 | 28.04 | 1.11 |
| pt7 | 0.62 | 42.47 | 15.58 | 40.47 | 0.86 |
| pt8 | 1.06 | 42.88 | 15.33 | 39.68 | 1.05 |
| Average | 3.0 | 40.3 | 16.4 | 39.3 | 1.0 |

### Example 2

The cathode powder for Ex. 2 (3 wt % LiCoPO₄ surface treated NMC442 (Li[Liₓ(Ni_{0.42}Mn_{0.42}Co_{0.16})₁₋ₓ]O₂ with x˜0.05) was prepared as follows: 162.93 g of Co(NO₃)₂.6H₂O (from Sigma-Aldrich) and 73.895 g of (NH₄)₂HPO₄ (from Sigma-Aldrich) were dissolved into 800 ml DI water in a stainless steel cylindrical shaped container then stirred overnight. 3.0 kg of cathode power NMC442 (as BC-723K from 3M, Li[Liₓ(Ni_{0.42}Mn_{0.42}Co_{0.16})₁₋ₓ]O₂ with x˜0.05) as in the Example 1 were added slowly into the container to make slurry. Small amounts of DI water were added as needed to maintain smooth stirring. After stirring for about 30 minutes, 20.685 g of Li₂CO₃ (from Sigma-Aldrich) was added into the container. The slurry was slowly heated, with stirring, to about 80° C. until the water was almost dried out and stirring ceased. The container was then placed in a 100° C. oven overnight to dry out the water completely. The powder in the container was tumbled to loosen and then baked at 800° C. for 4 hours. The powder was passed through 75 um pore sized sieves before use.

### Example 3

The cathode powder for Ex. 3 (3 wt % LaPO₄ surface treated NMC532 Li[Liₓ(Ni_{0.50}Mn_{0.30}Co_{0.20})₁₋ₓ]O₂ with x˜0.03) was prepared in the same manner as Ex. 1. The NMC532 was obtained from Umicore Korea as TX10.

### Example 4

The cathode powder for Ex. 4 (3 wt % LiCoPO₄ surface treated NMC532 Li[Liₓ(Ni_{0.50}Mn_{0.30}Co_{0.20})₁₋ₓ]O₂ with x˜0.03) was prepared in the same manner as Ex. 2. The NMC532 was obtained from Umicore Korea as TX10.

### Example 5

The cathode powder for Ex. 5 (3 wt % LaPO₄ surface treated NMC111 (Li[Liₓ(Ni_{0.333}Mn_{0.333}Co_{0.333})₁₋ₓ]O₂ with x˜0.03) was prepared as in the same manner as Ex 1. The NMC111 was obtained from 3M as BC-618K.

### Example 6

The cathode powder for Ex. 6 (3 wt % LiCoPO₄ surface treated NMC 111 (Li[Liₓ(Ni_{0.333}Mn_{0.333}Co_{0.333})₁₋ₓ]O₂ with x˜0.03) was prepared as in the same manner as Ex 2. The NMC111 was from 3M as BC-618K.

### Example 7

The cathode powder for Ex. 7 (3 wt % LiCoPO₄ surface treated Ni_{0.56}Mn_{0.40}Co_{0.04} (Li[Liₓ(Ni_{0.56}Mn_{0.40}Co_{0.04})₁₋ₓ]O₂ with x˜0.09) was prepared as in the same manner as Ex 2. Ni_{0.56}Mn_{0.40}Co_{0.04} oxide (Li[Liₓ(Ni_{0.56}Mn_{0.40}Co_{0.04})₁₋ₓ]O₂ with x˜0.09) was obtained by the process described below.

[Ni_{0.56}Mn_{0.40}Co_{0.04}](OH)₂ was obtained first as following: 50 l of 0.4M NH₃ solution was added into the chemical reactor with a diameter of 60 cm, purging with N₂ gas to get rid of any air or oxygen inside the reactor and heated the reactor to 50° C. and maintain it at a constant temperature of 50° C. Stirring inside the reactor was on and driven by a motor with frequency of 60 Hz. 2M of [Ni_{0.56}Mn_{0.40}Co_{0.04}]SO₄ solution was then pumped into the reactor at a speed of about 20 ml/min, Meanwhile, about 14.8M of NH₃ solution was also pumped into the reactor at the speed of about 0.67 ml/min. In order to maintain a stable pH inside the reactor between 10.5 and 10.9, 50 wt % NaOH solution was also pumped into the reactor with the pump speed determined by pH meter. After about 20 hours, the suitable particle sized Ni_{0.56}Mn_{0.40}Co_{0.04}](OH)₂ was obtained. The hydroxide was filtered out and washed with 0.5M NaOH once and then five times with water to remove any sulfate impurity. Finally, it was filtered and dried at about 120° C. overnight.

1.0 kg of dried Ni_{0.56}Mn_{0.40}Co_{0.04}](OH)₂ was blended with 552 g of LiOH.H₂O for about 30 minutes. The mixture was then transferred to a large alumina based crucible and baked at 480° C. for three hours, then 880° C. for 12 hours. The baked sample was cooled to room temperature within about 6 hours. The powder was passed through 75 um pore sized sieves before use. By this process, the powder Li[Liₓ(Ni_{0.56}Mn_{0.40}Co_{0.04})₁₋ₓ]O₂ with x˜0.09 was produced.

### Example 8

The cathode powder for Ex. 8 (3 wt % Ca_{1.5}PO₄ surface treated NMC442 (Li[Liₓ(Ni_{0.42}Mn_{0.42}Co_{0.16})₁₋ₓ]O₂ with x˜0.05) was prepared as follows: 6.85 g of Ca(NO₃)₂.4H₂O (≧98%, from Sigma-Aldrich) and 2.55 g of (NH₄)₂HPO₄ (≧98%, from Sigma-Aldrich) were dissolved into about 80 ml DI water in a stainless steel cylindrical shaped container. After Stirring for two hours, 100 g of cathode power NMC442 (as BC-723K from 3M, Li[Liₓ(Ni_{0.42}Mn_{0.42}Co_{0.16})₁₋ₓ]O₂ with x˜0.05) were added slowly into the container to make a slurry. Small amounts of DI water were added as needed to keep the slurry stirring smoothly. After stirring overnight, the container was slowly heated, with stirring, to about 80° C. until the water was almost dried out and stirring ceased. The container was then placed in a 100° C. oven overnight to dry out the water completely. The powder in the container was tumbled to loosen then baked at 800° C. for 2 hours. The powder was passed through 75 um pore sized sieves before use.

### Example 9

The cathode powder for Ex. 9 (1.5 wt % LaPO4 surface treated NMC442 (Li[Liₓ(Ni_{0.42}Mn_{0.42}Co_{0.16})₁₋ₓ]O₂ with x˜0.05) was prepared as follows: 83.89 g of La(NO₃)₃.6H₂O (≧98%, from Sigma-Aldrich) and 25.452 g of (NH₄)₂HPO₄ (≧98%, from Sigma-Aldrich) were dissolved into 800 ml DI water in a stainless steel cylindrical shaped container and stirred for two hours. 3.0 kg of cathode power NMC442 (as BC-723K from 3M, Li[Liₓ(Ni_{0.42}Mn_{0.42}Co_{0.16})₁₋ₓ]O₂ with x˜0.05) were added slowly into the container to make a slurry. Small amounts of DI water were added as needed to keep the slurry stirring smoothly. After stirring overnight, the container was slowly heated, with stirring, to about 80° C. until the water was almost dried out and stirring ceased. The container was then placed in a 100° C. oven overnight to dry out the water completely. The powder in the container was tumbled to loosen then baked at 800° C. for 4 hours. The powder was passed through 75 um pore sized sieves before use.

### Example 10

The cathode powder for Ex. 10 (1.5 wt % LiCoPO₄ surface treated NMC442 (Li[Liₓ(Ni_{0.42}Mn_{0.42}Co_{0.16})₁₋ₓ]O₂ with x˜0.05) was prepared as follows: 2.714 g of Co(NO₃)₂.6H₂O (from Sigma-Aldrich) and 1.242 g of (NH₄)2HPO₄ (from Sigma-Aldrich) were dissolved into about 80 ml DI water in a stainless steel cylindrical shaped container and stirred overnight. 100 g of cathode power NMC442 (as BC-723K from 3M, Li[Liₓ(Ni_{0.42}Mn_{0.42}Co_{0.16})₁₋ₓ]O₂ with x˜0.05) as in the example 1 were added slowly into the container to make a slurry. Small amounts of DI water were added as needed to keep the slurry stirring smoothly. After stirring for about 30 mins, 0.348 g of Li₂CO₃ (from Sigma-Aldrich) was added into the container. With stirring on, the container was slowly heated to about 80° C. until the water was almost dried out and stirring ceased. The container was then placed in a 100° C. oven overnight to dry out the water completely. The powder in the container was tumbled to loosen then baked at 800° C. for 4 hours. The powder was passed through 75 um pore sized sieves before use.

### Comparative Example 2

The cathode powder for Comp Ex 2 (3 wt % LaF3 surface treated NMC442 (Li[Liₓ(Ni_{0.42}Mn_{0.42}Co_{0.16})₁₋ₓ]O₂ with x˜0.05) was prepared as follows: 6.63 g of La(NO₃)₃.6H2O (≧98%, from Sigma-Aldrich) and 1.70 g of (NH4)F (≧98%, from Sigma-Aldrich) were dissolved in about 100 ml DI water in a stainless steel cylindrical shaped container and stirred for two hours. 100 g of cathode power NMC442 (as BC-723K from 3M, Li[Liₓ(Ni_{0.42}Mn_{0.42}Co_{0.16})₁₋ₓ]O₂ with x˜0.05) were added slowly into the container to make a slurry. Small amounts of DI water were added as needed to keep the slurry stirring smoothly. After stirring overnight, the container was slowly heated, with stirring, to about 80° C. until the water was almost dried out and stirring ceased. The container was then placed in a 100° C. oven overnight to dry out the water completely. The powder in the container was tumbled to loosen then baked at 800° C. for 2 hours. The powder was passed through 75 um pore sized sieves before use.

### Comparative Example 3

The cathode powder for Comp Ex3 (3 wt % CaF2 surface treated NMC442 (Li[Liₓ(Ni_{0.42}Mn_{0.42}Co_{0.16})₁₋ₓ]O₂ with x˜0.05) was prepared as follows: 9.07 g of Ca(NO₃)₂.4H₂O (≧98%, from Sigma-Aldrich) and 2.85 g of (NH4)F (≧98%, from Sigma-Aldrich) were dissolved into about 100 ml DI water in a stainless steel cylindrical shaped container and stirred for two hours. 100 g of cathode power NMC442 (as BC-723K from 3M, Li[Liₓ(Ni_{0.42}Mn_{0.42}Co_{0.16})₁₋ₓ]O₂ with x˜0.05) were added slowly into the container to make a slurry. Small amounts of DI water were added as needed to keep the slurry stirring smoothly. After stirring overnight, the container was slowly heated, with stirring, to about 80° C. until the water was almost dried out and stirring ceased. The container was then placed in a 100° C. oven overnight to dry out the water completely. The powder in the container was tumbled to loosen then baked at 800° C. for 2 hours. The powder was passed through 75 um pore sized sieves before use.

### Comparative Example 4

The cathode powder for Comparative Example 4 was prepared in the same manner as Example 8, except the powder was baked at 500° C.

### Comparative Example 5

The cathode powder for Comparative Example 4 was prepared in the same manner as Example 8, except the powder was baked at 500° C.

### Comparative Example 6

The cathode powder for Comparative Example 6 was prepared in the same manner as Example 2, except the powder was baked at 500° C.

The above examples were summarized in Table 2.

TABLE 2
Example Summary

| | | Heat treat | Ni:Mn:Co atomic |
|---|---|---|---|
| | | Temperature | ratio in the parent |
| Sample | Description | (° C.) | oxide phase |
| Ex. 1 | 3 wt % LaPO4 surface treated | 800° C. | 0.42:0.42:0.16 |
| | NMC442 | | |
| | (Li[Liₓ(Ni_{0.42}Mn_{0.42}Co_{0.16})₁₋ₓ]O₂ | | |
| | with x ~0.05) | | |
| Comp | 3 wt % LaPO4 surface treated | 500° C. | 0.42:0.42:0.16 |
| Ex 1 | NMC442 | | |
| | (Li[Liₓ(Ni_{0.42}Mn_{0.42}Co_{0.16})₁₋ₓ]O₂ | | |
| | with x ~0.05) | | |
| Ex. 2 | 3 wt % LiCoPO4 surface treated | 800° C. | 0.42:0.42:0.16 |
| | NMC442 | | |
| | (Li[Liₓ(Ni_{0.42}Mn_{0.42}Co_{0.16})₁₋ₓ]O₂ | | |
| | with x ~0.05) | | |
| Ex. 3 | 3 wt % LaPO4 surface treated | 800° C. | 0.50:0.30:0.20 |
| | NMC532 | | |
| | Li[Liₓ(Ni_{0.50}Mn_{0.30}Co_{0.20})₁₋ₓ]O₂ | | |
| | with x ~0.03) | | |
| Ex. 4 | 3 wt % LiCoPO4 surface treated | 800° C. | 0.50:0.30:0.20 |
| | NMC532 | | |
| | Li[Liₓ(Ni_{0.50}Mn_{0.30}Co_{0.20})₁₋ₓ]O₂ | | |
| | with x ~0.03) | | |
| Ex. 5 | 3 wt % LaPO4 surface treated | 800° C. | 0.333:0.333:0.333 |
| | NMC111 | | |
| | (Li[Liₓ(Ni_{0.333}Mn_{0.333}Co_{0.333})₁₋ₓ]O₂ | | |
| | with x ~0.03) | | |
| Ex. 6 | 3 wt % LiCoPO4 surface treated | 800° C. | 0.333:0.333:0.333 |
| | NMC111 | | |
| | (Li[Liₓ(Ni_{0.333}Mn_{0.333}Co_{0.333})₁₋ₓ]O₂ | | |
| | with x ~0.03 | | |
| Ex. 7 | 3 wt % LiCoPO4 surface treated | 800° C. | 0.56:0.40:0.04 |
| | Ni0.56Mn0.40Co0.04 | | |
| | (Li[Liₓ(Ni_{0.56}Mn_{0.40}Co_{0.04})₁₋ₓ]O₂ | | |
| | with x ~0.09) | | |
| Ex. 8 | 3 wt % Ca_{1.5}PO4 surface treated | 800° C. | 0.42:0.42:0.16 |
| | NMC442 | | |
| | (Li[Liₓ(Ni_{0.42}Mn_{0.42}Co_{0.16})₁₋ₓ]O₂ | | |
| | with x ~0.05) | | |
| Ex. 9 | 1.5 wt % LaPO4 surface treated | 800° C. | 0.42:0.42:0.16 |
| | NMC442 | | |
| | (Li[Liₓ(Ni_{0.42}Mn_{0.42}Co_{0.16})₁₋ₓ]O₂ | | |
| | with x ~0.05) | | |
| Ex. 10 | 1.5 wt % LiCoPO4 surface treated | 800° C. | 0.42:0.42:0.16 |
| | NMC442 | | |
| | (Li[Liₓ(Ni_{0.42}Mn_{0.42}Co_{0.16})₁₋ₓ]O₂ | | |
| | with x ~0.05) | | |
| Comp | 3 wt % LaF3 surface treated | 800° C. | 0.42:0.42:0.16 |
| Ex 2 | NMC442 | | |
| | (Li[Liₓ(Ni_{0.42}Mn_{0.42}Co_{0.16})₁₋ₓ]O₂ | | |
| | with x ~0.05) | | |
| Comp | 3 wt % CaF2 surface treated | 800° C. | 0.42:0.42:0.16 |
| Ex 3 | NMC442 | | |
| | (Li[Liₓ(Ni_{0.42}Mn_{0.42}Co_{0.16})₁₋ₓ]O₂ | | |
| | with x ~0.05) | | |
| Comp | 3 wt % Ca_{1.5}PO4 surface treated | 500° C. | 0.42:0.42:0.16 |
| Ex 4 | NMC442 | | |
| | (Li[Liₓ(Ni_{0.42}Mn_{0.42}Co_{0.16})₁₋ₓ]O₂ | | |
| | with x ~0.05) | | |
| Comp | 3 wt % LaPO4 surface treated | 500° C. | 0.50:0.30:0.20 |
| Ex 5 | NMC532 | | |
| | Li[Liₓ(Ni_{0.50}Mn_{0.30}Co_{0.20})₁₋ₓ]O₂ | | |
| | with x ~0.03) | | |
| Comp | 3 wt % LiCoPO4 surface treated | 500° C. | 0.42:0.42:0.16 |
| Ex 6 | NMC442 | | |
| | (Li[Liₓ(Ni_{0.42}Mn_{0.42}Co_{0.16})₁₋ₓ]O₂ | | |
| | with x ~0.05) | | |

### Example 11

The cathode powder for Ex. 11 (3 wt % LiCoPO₄ surface treated core-shell type NMC oxides (67 mol % Li[Li_{0.091}Ni_{0.606}Mn_{0.303}]O₂ as core and 33 mol % Li[Li_{0.091}Ni_{0.15}Co_{0.15}Mn_{0.609}]O₂ as shell)) was prepared in the same manner as Ex. 2. The core-shell type NMC oxide was obtained based the process disclosed in patent application WO 2012/112316 A1 (herein incorporated by reference) and described above.

### Example 12

The cathode powder for Ex. 12 (2 wt % LiCoPO4 surface treated core-shell type NMC oxides (67 mol % Li[Li_{0.091}Ni_{0.606}Mn_{0.303}]O₂ as core and 33 mol % Li[Li_{0.091}Ni_{0.15}Co_{0.15}Mn_{0.609}]O₂ as shell)) was prepared as follows using the core-shell type NMC hydroxide prepared as described above and disclosed in patent application WO 2012/112316 A1.

0.543 g of Co(NO₃)₂.6H₂O (from Sigma-Aldrich) was dissolved into about 100 ml DI water in a glass beaker. 9.486 g of core-shell hydroxide (67 mol % [Ni0.667Mn0.333](OH)₂ as core and 33 mol % [Ni0.165Co0.165Mn0.67](OH)₂ as shell) was put into the Co(NO₃).6H₂O solution to form a slurry. The slurry was stirred for about 1 hour before 0.164 grams of (NH₄)₂HPO₄ (from Sigma-Aldrich) was added. After stirring for about another hour, the powder was recovered by drying at about 90° C. with stirring. 9.715 grams of recovered powder and 5.299 grams of LiOH.H₂O (from Sigma-Aldrich) were mixed in a blender for one minute. The mixture was heated up to 500° C. for 4 hours followed by the final calcination at 900° C. for 12 hours. The resulting powder was sieved with a 106 μm mesh before use.

### Example 13

The cathode powder for Ex. 13 (2 wt % Li₍₃₋₂ₓ₎MₓPO₄ (M is Ni or Co or Mn or any combination) surface treated core-shell type NMC oxides (67 mol % Li[Li_{0.091}Ni_{0.606}Mn_{0.303}]O₂ as core and 33 mol % Li[Li_{0.091}Ni_{0.15}Co_{0.15}Mn_{0.609}]O₂ as shell)) was prepared as follows using the core-shell type NMC hydroxide prepared as described above and disclosed in patent application WO 2012/112316 A1.

0.164 g of (NH₄)₂HPO₄ (from Sigma-Aldrich) was dissolved in about 100 ml DI water in a glass beaker. 9.486 grams of core-shell hydroxide (67 mol % [Ni0.667Mn0.333](OH)₂ as core and 33 mol % [Ni_{0.165}Co_{0.165}Mn_{0.67}](OH)₂ as shell) was put into the (NH₄)₂HPO₄ solution to form a slurry after one-hour's stirring. With stirring on, the slurry was dried up at about 90° C. to recover the powder. 9.652 grams of the recovered powder was mixed with 5.299 grams of LiOH.H2O (from Sigma-Aldrich) in a blender for one minute. The mixture was heated up to 500° C. for 4 hours followed by the final calcination at 900° C. for 12 hours. The resulting powder was sieved with a 106 μm mesh before use.

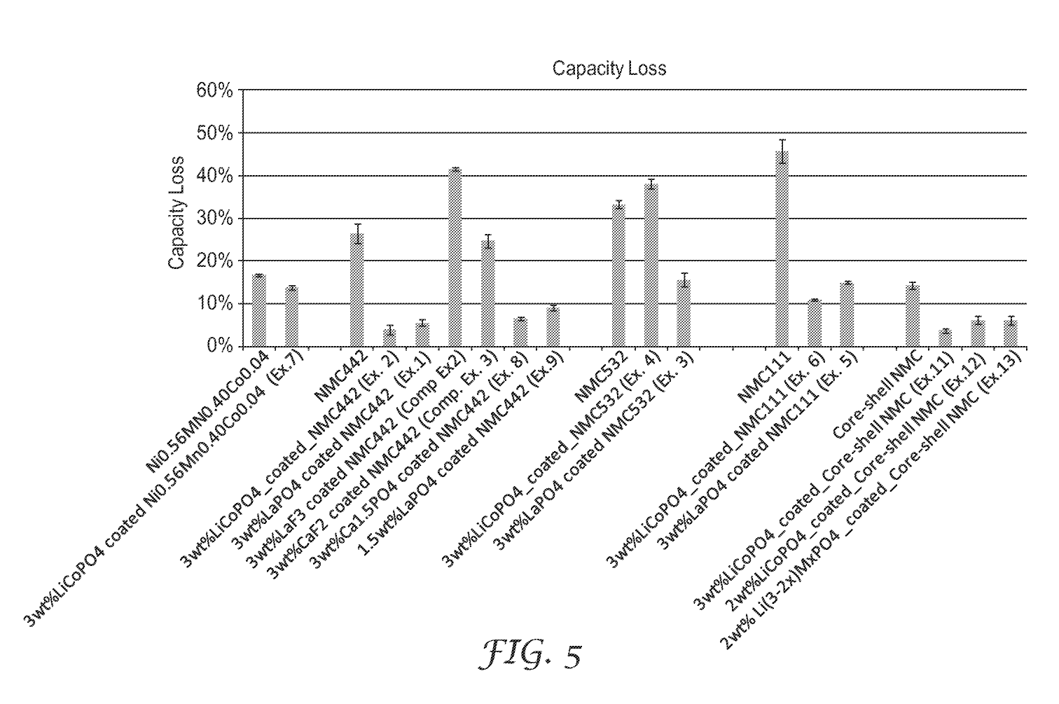

All the above examples and comparative examples were tested by floating test in coin cells as cathode electrodes. MCMB type graphite (from E-one Moli Energy Ltd) was used as the anode. The electrolyte was: 92 wt % (1M LiPF6 in EC:EMC (3:7 by vol))+6 wt % PC+2 wt % FEC. (EC: ethylene carbonate, EMC: ethyl methyl carbonate; PC: Propylene carbonate; FEC: fluoroethylene carbonate). All the coin cells were test at 50° C. The cells were first cycled for three cycles between 3.0 and 4.6V to obtain the reversible capacity. (Constant current/constant voltage mode charging using 0.3 mA, the cutoff current less than 0.1 mA; constant current discharging using 0.3 mAh). The cells were then charged to 4.6V and kept at 4.6V for 200 hrs (It is called floating test). After floating, the cells were cycled for another four cycles to obtain the reversible capacity and compare it to the reversible capacity before floating to determine the irreversible capacity loss. The capacity loss for Ex 1-9 and 11-13 and Comp Ex 2-3 were plotted in FIG. 5.

Surprisingly, FIG. 5 shows that LiCoPO₄, Ca_{1.5}PO₄ or LaPO₄ type surface treatment onto NMC442 has benefits for the capacity retention in the high voltage high temperature floating test, but little benefit from the LaF₃ or CaF₂ type surface treatment onto NMC442. It was believed that all the surface treatments would benefit the capacity retention. It was further concluded that the benefit of LiCoPO₄ type surface treatment strongly depends on the Ni:Mn ratio. For NMC532 or Ni0.56Mn0.40Co0.04, the benefit of LiCoPO₄ type surface treatment is very small or even worse. LiCoPO₄ type coating or similar phosphate coating also benefits to high temperature high voltage capacity retention of the core-shell structure NMC oxide. The surface of the core-shell type NMC oxide had atomic ratio Ni/Mn<1.

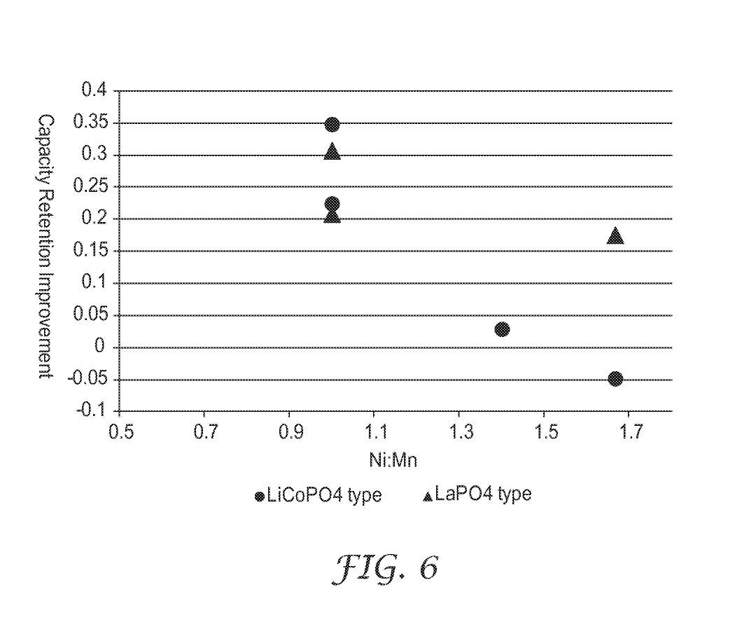

FIG. 6 shows the capacity retention improvement (defined as the difference of the capacity loss before and after surface treatment with LiCoPO₄) as a function of the Ni/Mn ratio. Surprisingly, FIG. 6 shows the LiCoPO₄ type coating has significant benefit when Ni/Mn≦1. For LaPO₄ type surface treatment, the capacity retention improvement benefit dependence on the Ni/Mn ratio is much smaller.

For LiCoPO₄ type surface treatment, after being baked at 800° C., it is believed that there are partial diffusion into each other between surface treated compound “LiCoPO₄” and parent compound NMC (Li[Liₓ(NiₐMn_{b}Co_{c})₁₋ₓ]O₂ with x>0, a>0, b>0, c>0, a+b+c=1). However, because of the size and charge state, diffusion depth for each element is not the same. In this case, the target coating composition “LiCoPO₄” could potentially become Li_{f}M_{g}[PO₄]_{1-f-g} (M=the combination Co and/or Ni and/or Mn); 0≦f<1, 0≦g<1;). For best performance, the surface treated NMC oxide has to go through high temperature baking process such as 800° C. It is possible to obtain the LiCoPO₄ type surface treated NMC in one step high temperature, sintering starting from NMC hydroxide, Li₂CO₃, and Co(NO3)₂.6H₂O and (NH₄)₂HPO₄ as demonstrate in Ex. 11.

For LaPO₄ type surface treatment, after being baked at 800° C., it is possible that the target coating composition LaPO₄ becomes Laₕ[PO₄]₁₋ₕ (0<h<1).

For Ca_{1.5}PO₄ type surface treatment, after being baked at 800° C., it is possible that the target coating composition Ca_{1.5}PO₄ becomes Caₕ[Pa]₁₋ₕ (0<h<1).

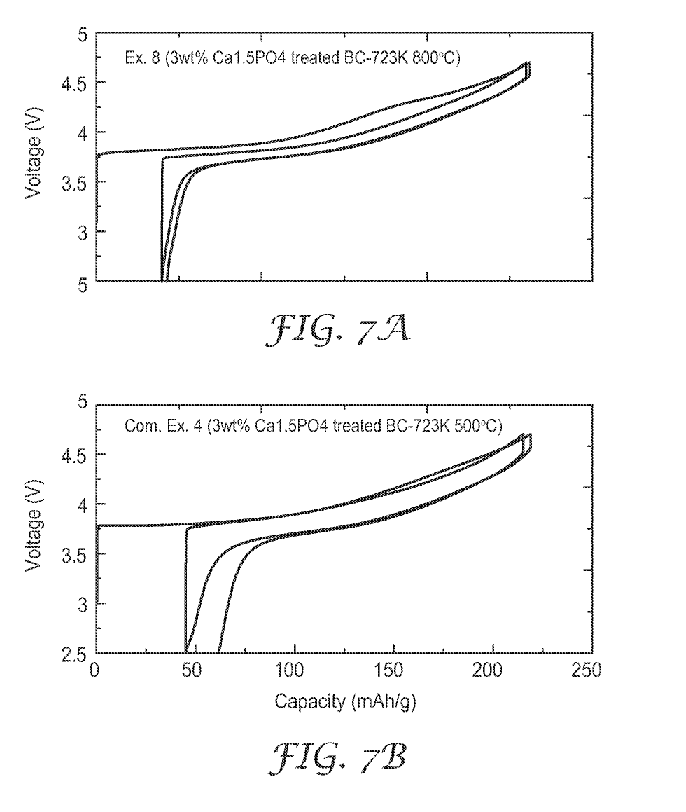

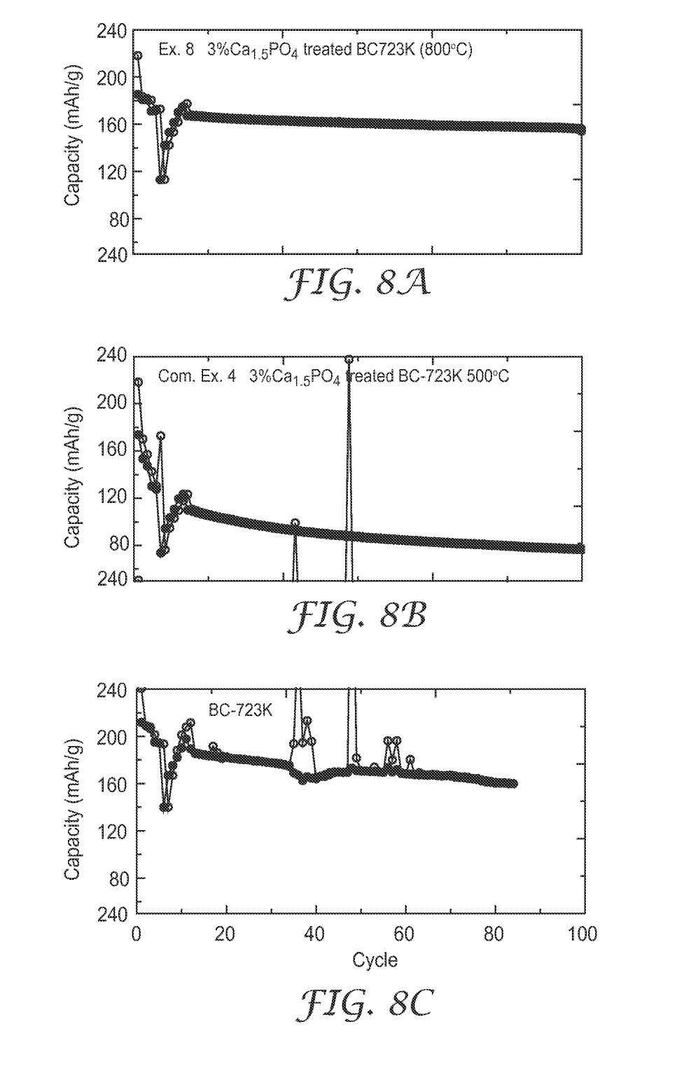

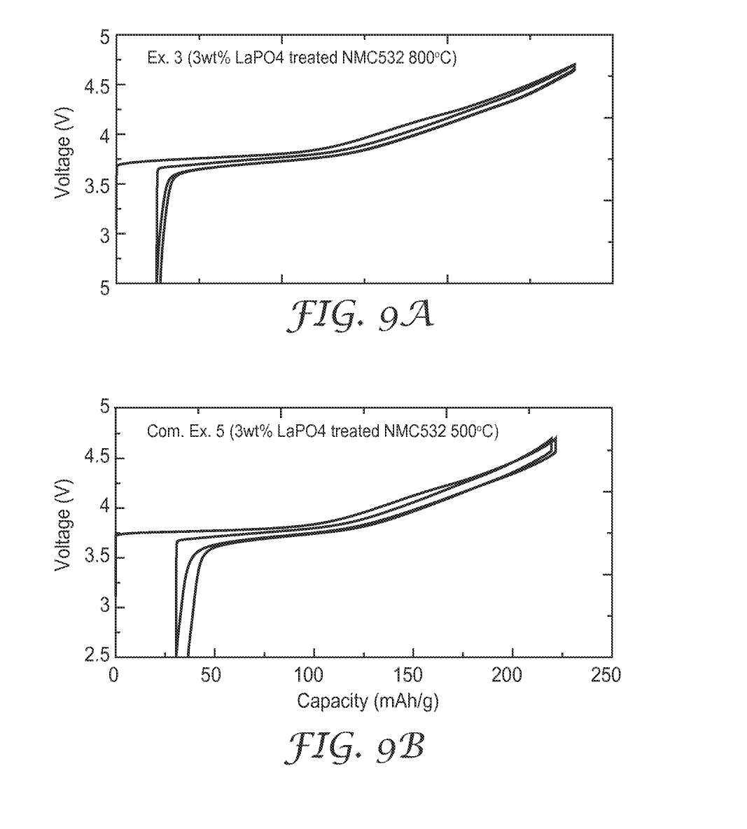

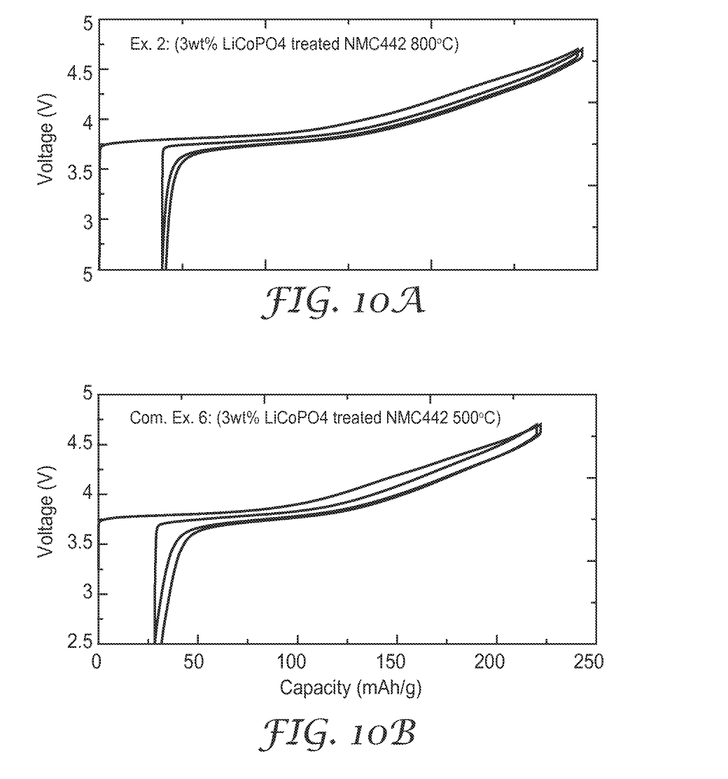

The cycling data shown in FIGS. 7-10 provided additional evidence that higher electrochemical performance were obtained for the surface coated samples which were baked at high temperature such as 800° C., comparing it to low baking temperature such as 500° C.

1. A cathode composition comprising:
particles having the following formula Li[Liₓ(NiₐMn_{b}Co_{c})₁₋ₓ]O₂, where 0<x<0.3, 0<a<1, 0<b<1, 0<c<1, a+b+c=1, a/b≦1; and
a coating composition comprising Li_{f}Co_{g}[PO₄]_{1-f-g} (0≦f<1, 0≦g<1) wherein the coating composition is disposed on an outer surface of the particles
wherein the composition has an O3 type structure; and
wherein the cathode composition, including the coating composition, has been subjected to baking at a temperature of 750° C. or higher for at least 30 minutes.

2. A cathode composition comprising:
particles having the following formula Li[Liₓ(NiₐMn_{b}Co_{c})₁₋ₓ]O₂, where 0<x<0.3, 0<a<1, 0<b<1, 0<c<1, a+b+c=1; and
a coating composition comprising Mₕ[PO₄]₁₋ₕ (0<h<1) wherein M comprises Ca, Sr, Ba, Y, any rare earth element (REE) or combinations thereof and wherein the coating composition is disposed on an outer surface of the particles;
wherein the particles have an O3 type structure; and
wherein the cathode composition, including the coating composition, has been subjected to baking at a temperature of 750° C. or higher for at least 30 minutes.

3. A cathode composition according to claim 2, wherein the phosphate-based coating comprises a material having the formula Caₕ[PO₄]₁₋ₕ where 0<h<1.

4. A cathode composition according to claim 2, wherein the phosphate-based coating comprises a material having the formula Laₕ[PO₄]₁₋ₕ where 0<h<1.

5. A lithium transition metal oxide composition according to claim 2, wherein the composition is in the form of a single phase.

6. A cathode composition comprising:
composite particles, the composite particles comprising:
a core comprising a layered lithium metal oxide having an O3 crystal structure,
wherein the layered lithium metal oxide comprises nickel, manganese, or cobalt,
wherein if the layered lithium metal oxide is incorporated into a cathode of a lithium-ion cell, and the lithium-ion cell is charged to at least 4.6 volts versus Li/Li⁺ and then discharged, then the layered lithium metal oxide exhibits no dQ/dV peaks below 3.5 volts, and
wherein the core comprises from 30 to 85 mole percent of the composite particle, based on the total moles of atoms of the composite particle;
a shell layer having an O3 crystal structure enclosing the core,
wherein the shell layer comprises an oxygen-loss, layered lithium metal oxide;
and a coating composition selected from Li_{f}M_{g}[PO₄]_{1-f-g} wherein M is Co, Ni or Mn or a combination thereof; 0≦f<1, 0≦g<1) or
Mₕ[PO₄]₁₋ₕ (0<h<1), wherein M comprises Ca, Sr, Ba, Y, La, any rare earth element (REE) or combinations thereof,
wherein the coating composition is disposed on an outer surface of the particles;
wherein the cathode composition, including the coating composition, has been subjected to baking at a temperature of 750° C. or higher for at least 30 minutes.

7. The cathode composition of claim 6, wherein the shell composition has a Ni/Mn atomic ratio that is less than or equal to one.

8. The cathode composition of claim 6, wherein the capacity of the composite particle is greater than the capacity of the core.

9. The cathode composition of claim 6, wherein the shell layer is selected from the group consisting of Li[Li_{0.2}Mn_{0.54}Ni_{0.13}Co_{0.13}]O₂ and Li[Li_{0.06}Mn_{0.525}Ni_{0.415}]O₂.

10. A method for making a cathode composition, the method
comprising:
forming a cathode composition according to claim 6; and
heating the cathode composition at a temperature of 750° C. or higher for at least 30 minutes.

11. A lithium-ion battery comprising:
an anode;
a cathode comprising a composition according to claim 1; and
an electrolyte.

12. A cathode composition comprising:
particles having the following formula Li[Liₓ(NiₐMn_{b}Co_{c})₁₋ₓ]O₂, where 0<x<0.3, 0<a<1, 0<b<1, 0<c<1, a+b+c=1; and
a coating composition comprising Mₕ[PO₄]₁₋ₕ (0<h<1) wherein M comprises Ca, Sr, Ba, Y, any rare earth element (REE) or combinations thereof and wherein the coating composition is disposed on an outer surface of the particles;
wherein the particles have an O3 type structure; and
wherein there is an observed diffraction peak is between 30 and 35 degrees in X-ray
diffraction patterns using Cu Ka wavelength.
